(19) United States
(12) Patent Application Publication
(10) Pub. No.: US 2018/0239332 A1
(43) Pub. Date: Aug. 23, 2018

(54) Machine Tool

(71) Applicant: DMG Mori Co., LTD., Nara (JP)

(72) Inventors: Tsutomu KURAMOTO, Nara (JP); Tsunehito NAKAHIGASHI, Nara (JP)

(73) Assignee: DMG Mori Co., LTD., Nara (JP)

(21) Appl. No.: 15/747,392

(22) PCT Filed: May 19, 2016
(86) PCT No.: PCT/JP2016/064817

§ 371 Date: Jan. 24, 2018

(30) Foreign Application Priority Data
Aug. 24, 2015 (JP) 2015-164576

(51) Int. Cl. G05B 19/404; B23Q 7/04

(52) U.S. Cl. CPC G05B 19/404; G05B 2219/37621; G05B 2219/50289; B23Q 7/04

(57) ABSTRACT

A machine tool that attaches and detaches workpieces to and from a spindle in a shorter time includes: a machining mechanism part including a spindle, a tool rest, a first-axis feed mechanism moving the spindle in a a first axis extending along a center axis of the spindle, and a second-axis feed mechanism relatively moving the spindle and the tool rest in a second axis orthogonal to the first axis; a loading mechanism part including holding parts for holding a workpiece, and a third-axis feed mechanism moving the holding parts in a third axis orthogonal to the first axis to position them at the transfer position; and a numerical controller. The numerical controller operates to move the spindle toward the transfer position and to position the holding parts at the transfer position such that the operations at least partially overlap.

### TECHNICAL FIELD

The present invention relates to a machine tool including a machining mechanism part having a spindle holding and rotating a workpiece, and a loading mechanism part transferring and receiving a workpiece to and from the spindle.

### BACKGROUND ART

A conventionally known example of a machine tool as mentioned above is a machine tool disclosed in Japanese Unexamined Utility Model Application Publication No. H1-71003 (Patent Literature 1 listed below). This machine tool consists of a double-spindle lathe and a loader device transferring and receiving a workpiece to and from the double-spindle lathe.

The double-spindle lathe includes two spindles, right and left spindles, disposed such that their axes are parallel to each other in a horizontal plane. Each spindle has a chuck attached to an end thereof and the chuck clamps a workpiece. Further, on either side of the two spindles arranged in parallel, a tool turret is arranged corresponding to each spindle, the tool turret being configured to be movable in a direction extending along the axes of the spindles (so-called Z-axis direction) and in a direction orthogonal to the axes of the spindles in a horizontal plane (so-called X-axis direction). Movement of each tool turret in the X-axis and Z-axis directions causes a workpiece attached to the corresponding spindle to be machined by a tool attached to the tool turret.

The loader device is arranged at a position right above the double-spindle lathe, and is composed of a first slide member travelling laterally in parallel to the front side of the lathe, a second slide member arranged on the first slide member and moving forward and backward in a horizontal direction orthogonal to the travelling direction of the first slide member, and a loader chuck arm hanging down from the second slide member, having a loader chuck at a lower end thereof, and arranged to be vertically movable.

The loader chuck has chucks for clamping a workpiece on vertical and horizontal surfaces thereof that are perpendicular to each other, and is configured to be able to be rotated about an axis of rotation set at 45 degrees with respect to the horizontal surface (or the vertical surface) by a tilt mechanism. 180-degree rotation of the loader chuck causes one of the chucks to be vertically arranged and face the chucks of the spindles and causes the other of the chucks to be horizontally arranged and face downward.

Further, a reversing device is arranged above the spindles, the reversing device being composed of a fixed chuck and a turning chuck configured to face the fixed chuck when being turned 180 degrees. As viewed from the front side, the fixed chuck is arranged above the spindle located on the left and the turning chuck is arranged above the spindle located on the right.

Although not described in detail in Patent Literature 1, the thus-configured loader device operates as described below.

1. Loaded Workpiece Clamping Operation

The loader chuck arm is moved in a two-dimensional plane by the first slide member and the second slide member to position the loader chuck at a position above a workpiece positioned at a loading position. Thereafter, the loader chuck arm is moved downward and then the workpiece is clamped by the horizontally arranged chuck of the loader chuck (this chuck is referred to as “first chuck”). Thereafter, the loader chuck arm is moved upward to the initial position. Through these operations, the loaded workpiece is clamped by the first chuck. Note that the loading position has a workpiece loaded thereto by an appropriate loading device.

2. Workpiece Attachment/Detachment Operation for Spindle on the Left (Left Spindle)

Subsequently, the loader chuck arm is moved in a two-dimensional plane by the first slide member and the second slide member and then the loader chuck arm is moved downward to cause the vertically arranged chuck of the loader chuck (this chuck is referred to as “second chuck”) to face the left spindle. Thereafter, the loader chuck arm is moved toward the left spindle by the second slide member and a semi-machined workpiece clamped by the chuck of the left spindle is transferred to the second chuck. Thereafter, the loader chuck arm is moved away from the left spindle by the second slide member. Thereafter, the first chuck clamping the loaded workpiece is brought into the vertical state by the tilt mechanism of the loader chuck and simultaneously the second chuck clamping the semi-machined workpiece is brought into the horizontal state. Thereafter, the loader chuck arm is moved again toward the left spindle by the second slide member and the loaded workpiece clamped by the first chuck is transferred to the chuck of the left spindle. Thereafter, the loader chuck arm is moved away from the left spindle by the second slide member, and then the loader chuck arm is moved upward. Through these operations, the semi-machined workpiece clamped by the chuck of the left spindle is replaced with the workpiece clamped by the first chuck of the loader chuck arm.

3. Reversing Operation by Reversing Device

Subsequently, the second chuck clamping the semi-machined workpiece is brought into the vertical state by the tilt mechanism of the loader chuck and simultaneously the first chuck is brought into the horizontal state. Note that, after this operation, the second chuck faces the fixed chuck of the reversing device. Thereafter, the loader chuck arm is moved toward the fixed chuck by the second slide member and the semi-machined workpiece clamped by the second chuck is transferred to the fixed chuck. Thereafter, the loader chuck arm is moved away from the fixed chuck by the second slide member. Thereafter, the turning chuck is turned 180 degrees so as to transfer the semi-machined workpiece from the fixed chuck to the turning chuck. Thereafter, the turning chuck is returned 180 degrees, thereby returning to the initial position. Through these operations, the front and rear sides of the semi-machined workpiece are reversed.

4. Semi-Machined Workpiece Clamping Operation

Subsequently, the loader chuck arm is shifted rightward by the first slide member to cause the second chuck to face the turning chuck. Thereafter, the loader chuck arm is moved toward the turning chuck by the second slide member and the semi-machined workpiece clamped by the turning chuck is transferred to the second chuck. Thereafter, the loader chuck arm is moved away from the turning chuck by the second slide member. Thereafter, the second chuck clamping the semi-machined workpiece is brought into the horizontal state by the tilt mechanism of the loader chuck and simultaneously the first chuck is brought into the vertical state. Through these operations, the semi-machined workpiece is transferred to the second chuck.

5. Workpiece Attachment/Detachment Operation for Spindle on the Right (Right Spindle)

Subsequently, the loader chuck arm is moved downward to cause the first chuck to face the right spindle. Thereafter, the loader chuck arm is moved toward the right spindle by the second slide member and a machined workpiece clamped by the chuck of the right spindle is transferred to the first chuck. Thereafter, the loader chuck arm is moved away from the right spindle by the second slide member. Thereafter, the second chuck clamping the semi-machined workpiece is brought into the vertical state by the tilt mechanism of the loader chuck and simultaneously the first chuck clamping the machined workpiece is brought into the horizontal state. Thereafter, the loader chuck arm is moved again toward the right spindle by the second slide member and the semi-machined workpiece clamped by the second chuck is transferred to the chuck of the right spindle. Thereafter, the loader chuck arm is moved away from the right spindle by the second slide member, and then the loader chuck arm is moved upward. Through these operations, the machined workpiece clamped by the chuck of the right spindle is replaced with the semi-machined workpiece clamped by the second chuck of the loader chuck. Note that the machined workpiece clamped by the first chuck is thereafter discharged to an appropriate discharge position by an appropriate operation of the loader device.

As described above, this conventional machine tool achieves an automatic machining in which workpieces clamped by chucks of two spindles are automatically attached and detached by a loader device.

### CITATION LIST

### Patent Literature

Patent Literature 1: Japanese Unexamined Utility Model Application Publication No. H1-71003

### SUMMARY OF INVENTION

### Technical Problem

By the way, in the field of machine tools, a shorter machining time is always desired in order to reduce production costs. Therefore, also in the above-described conventional machine tool, it is desired to further shorten not only the machining time of the two-spindle lathe but also the operation time for the workpiece attachment/detachment operation carried out by the loader device. According to the present inventors, it was found that the above-described conventional machine tool had room for further improvement in the attachment/detachment operation thereof.

The present invention has been achieved in view of the above-described circumstances, and an object thereof is to provide a machine tool which can carry out an operation of attaching and detaching workpieces to and from a spindle with a loading mechanism part in a shorter time than the conventional machine tool.

### Solution to Problem

The present invention, for solving the above-described problems, relates to a machine tool including:

a machining mechanism part including a spindle holding a workpiece and rotating the workpiece about a center axis of the spindle, a tool rest holding a tool, a first-axis feed mechanism moving the spindle forward and backward along a first axis extending along the center axis of the spindle, a second-axis feed mechanism relatively moving the spindle and the tool rest along a second axis orthogonal to the first axis;

a loading mechanism part transferring and receiving the workpiece to and from the spindle at a transfer position to which the spindle is moved forward along the first axis, the loading mechanism part including a holding part holding the workpiece, and a third-axis feed mechanism moving the holding part in a direction of a third axis orthogonal to the first axis to position the holding part at the transfer position; and

a numerical controller numerically controlling at least the first-axis feed mechanism, the second-axis feed mechanism, and the third-axis feed mechanism,

the numerical controller being configured to, for transferring the workpiece between the spindle and the loading mechanism part, execute an operation of moving the spindle toward the transfer position with the first-axis feed mechanism and an operation of positioning the holding part at the transfer position with the third-axis feed mechanism in a manner such that the operations at least partially overlap.

In this machine tool, the numerical controller numerically controls the first-axis feed mechanism to move the spindle forward and backward along the first axis and numerically controls the second-axis feed mechanism to relatively move the spindle and the tool rest along the second axis, whereby a workpiece held by the spindle is machined by a tool held by the tool rest.

Further, the numerical controller numerically controls the first-axis feed mechanism to move the spindle forward to the transfer position in the first-axis direction and numerically controls the third-axis feed mechanism to move the holding part of the loading mechanism part to the transfer position, thereby transferring a workpiece between the spindle and the holding part.

In this process, the numerical controller executes an operation of moving the spindle toward the transfer position by controlling the first-axis feed mechanism and an operation of positioning the holding part at the transfer position by controlling the third-axis feed mechanism in a manner such that these operations at least partially overlap.

In the above-described conventional machine tool, the loader chuck arm of the loader device is moved downward and then the loader chuck is moved toward the spindle; the operation of moving the loader chuck arm downward and the operation of moving the loader chuck toward the spindle are executed separately and independently. In contrast, in the machine tool according to the present invention, as described above, movement of the spindle along the first axis and movement of the holding part along the third axis are simultaneously executed in a partially overlapping manner; therefore, it is possible to shorten the operation time for these operations, and therefore it is possible to reduce costs for production using this machine tool.

In the present invention, a configuration is possible in which:

the first axis is horizontally arranged and the third axis is vertically arranged;

the loading mechanism part includes two said holding parts arranged in parallel along the third axis; and

the numerical controller is configured to control an operation of the third-axis feed mechanism so as to selectively position one of the holding parts at the transfer position.

With thus-configured loading mechanism part, first, in a state where a workpiece for replacement is held by one of the holding parts, the first-axis feed mechanism and the third-axis feed mechanism perform a transfer operation between the other of the holding parts and the spindle to transfer a machined workpiece held by the spindle to the other holding part. Subsequently, the first-axis feed mechanism and the third-axis feed mechanism perform the transfer operation for the second time between the one holding part and the spindle to cause the spindle to hold the new workpiece.

Thus, with the loading mechanism part having this configuration, it is possible to execute detachment of a machined workpiece held by the spindle and attachment of a new workpiece to the spindle in fewer operations. Therefore, it is possible to further shorten the operation time for the detachment and attachment of workpieces from and to the spindle, and therefore it is possible to further reduce the costs for production using the machine tool.

Further, in the present invention, another configuration is possible in which:

the first axis is horizontally arranged and the third axis is vertically arranged;

the loading mechanism part includes two said holding parts arranged in parallel along a horizontal fourth axis orthogonal to the first axis, and a fourth-axis feed mechanism moving the holding parts along the fourth axis; and

the numerical controller is configured to control operations of the third-axis feed mechanism and fourth-axis feed mechanism so as to selectively position one of the holding parts at the transfer position.

With the thus-configured loading mechanism part, first, in a state where a workpiece for replacement is held by one of the holding parts, the fourth-axis feed mechanism moves the two holding parts along the fourth axis to position the other of the holding parts at a position where the other holding part can face the spindle. Subsequently, the first-axis feed mechanism and the third-axis feed mechanism perform a transfer operation between the other holding part and the spindle to transfer a machined workpiece held by the spindle to the other holding part.

Subsequently, the fourth-axis feed mechanism moves the two holding parts along the fourth axis for the second time to position the one holding part at a position where the one holding part can face the spindle. Subsequently, the first-axis feed mechanism and the third-axis feed mechanism perform a transfer operation between the one holding part and the spindle to cause the spindle to hold the new workpiece.

Thus, also with the loading mechanism part having this configuration, it is possible to execute detachment of a machined workpiece held by the spindle and attachment of a new workpiece to the spindle in fewer operations. Therefore, it is possible to further shorten the operation time for the detachment and attachment of workpieces from and to the spindle, and therefore it is possible to further reduce the costs for production using the machine tool.

Further, in the present invention, the numerical controller may include a single CPU and be configured to process a workpiece transfer operation program with the CPU to simultaneously numerically control the first-axis feed mechanism of the machining mechanism part and the third-axis feed mechanism of the loading mechanism part.

With this configuration, it is possible to, when the first-axis feed mechanism of the machining mechanism part and the third-axis feed mechanism of the loading mechanism part are simultaneously numerically controlled, execute processings, such as causing their operation timings to coincide with each other, quickly with wasted time eliminated as much as possible.

Further, in the present invention, the numerical controller may be configured to,

when executing a machining program containing a position command for a workpiece coordinate system having its origin at a workpiece zero point, and numerically controlling the first-axis feed mechanism and the second-axis feed mechanism with respect to a machine coordinate system having its origin at a machine zero point, numerically control the first-axis feed mechanism and the second-axis feed mechanism using a workpiece offset amount for compensating for a difference between the workpiece zero point and the machine zero point, and

when executing the workpiece transfer operation program containing a position command for the machine coordinate system, and numerically controlling the first-axis feed mechanism and the third-axis feed mechanism with respect to the machine coordinate system, numerically control the first-axis feed mechanism and the third-axis feed mechanism without using the workpiece offset amount.

When controlling the first-axis feed mechanism, the second-axis feed mechanism, and the third-axis feed mechanism, which are to be numerically controlled, the numerical controller usually numerically controls them with respect to a machine coordinate system that has its origin at a machine zero point. On the other hand, machining in the machining mechanism part is executed in accordance with a machining program containing a position command for a workpiece coordinate system that has its origin at a workpiece zero point. Therefore, when numerically controlling the first-axis feed mechanism and the second-axis feed mechanism in accordance with the machining program, the numerical controller numerically controls the first-axis feed mechanism and the second-axis feed mechanism using a workpiece offset amount for compensating for a difference between the workpiece zero point and the machine zero point.

In contrast, the workpiece transfer operation between the holding parts of the loading mechanism part and the spindle, which is carried out by operations of the first-axis feed mechanism of the machining mechanism part and third-axis feed mechanism of the loading mechanism part, is executed in accordance with the workpiece transfer operation program that contains a position command for the machine coordinate system. Therefore, when the workpiece transfer operation program is executed and thereby the first-axis feed mechanism and the third-axis feed mechanism are numerically controlled, if control using the workpiece offset amount is maintained, it is not possible to accurately control the positional relationship between the spindle and the holding parts.

Therefore, in the present invention, when the workpiece transfer operation program that contains a position command for the machine coordinate system is executed and thereby the first-axis feed mechanism and the third-axis feed mechanism are numerically controlled with respect to the machine coordinate system, the first-axis feed mechanism and the third-axis feed mechanism are numerically controlled without using the workpiece offset amount. Note that, because the machining program and the workpiece transfer operation program are usually executed continuously and repeatedly, when the workpiece transfer operation program is executed, it is necessary to specially execute a processing which does not use the workpiece offset amount.

An exemplary specific mode for executing a processing which does not use the workpiece offset amount is such that the numerical controller is configured to determine whether to apply the workpiece offset amount based on a preset parameter and configured, in accordance with setting of the parameter, not to apply the workpiece offset amount when executing the workpiece transfer operation program.

Further, another exemplary mode is such that the numerical controller is configured to determine whether to apply the workpiece offset amount in accordance with a command for defining whether to apply the workpiece offset amount, the command being contained in the programs.

### Advantageous Effects of Invention

As described above, in the machine tool according to the present invention, movement of the spindle along the first axis and movement of the holding part along the third axis are simultaneously executed in a partially overlapping manner. Therefore, as compared with the conventional machine tool configured to execute these operations independently and separately, the machine tool according to the present invention can shorten the operation time for these operations, and therefore it is possible to reduce costs for production using this machine tool.

### BRIEF DESCRIPTION OF DRAWINGS

FIG. 1 is a perspective view of a machine tool according an embodiment of the present invention;

FIG. 2 is a side view of the machine tool shown in FIG. 1 as viewed from the direction of arrow A;

FIG. 3 is a side view of the machine tool shown in FIG. 1 as viewed from the direction of arrow B;

FIG. 4 is a front view of the machine tool shown in FIG. 1; and

FIG. 5 is a block diagram showing a numerical controller according to the embodiment.

### DESCRIPTION OF EMBODIMENTS

Hereinafter, an embodiment of the present invention will be described with reference to the drawings.

1. Configuration of Machine Tool

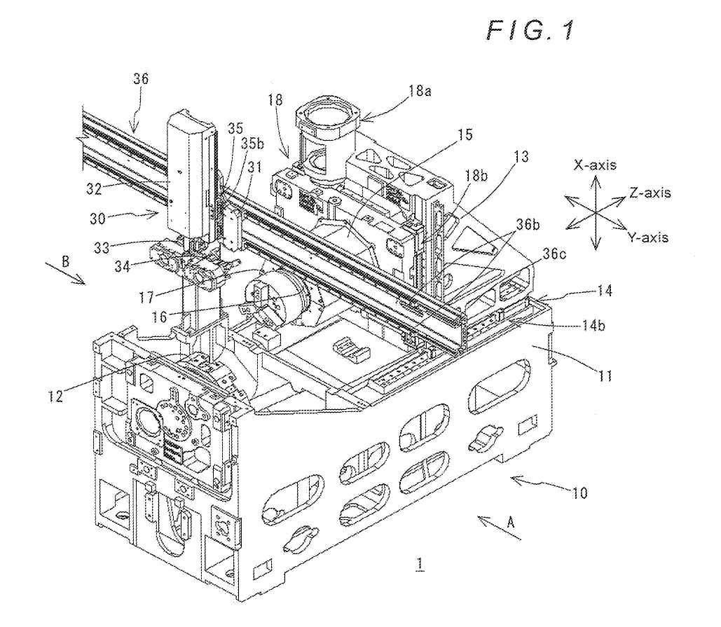

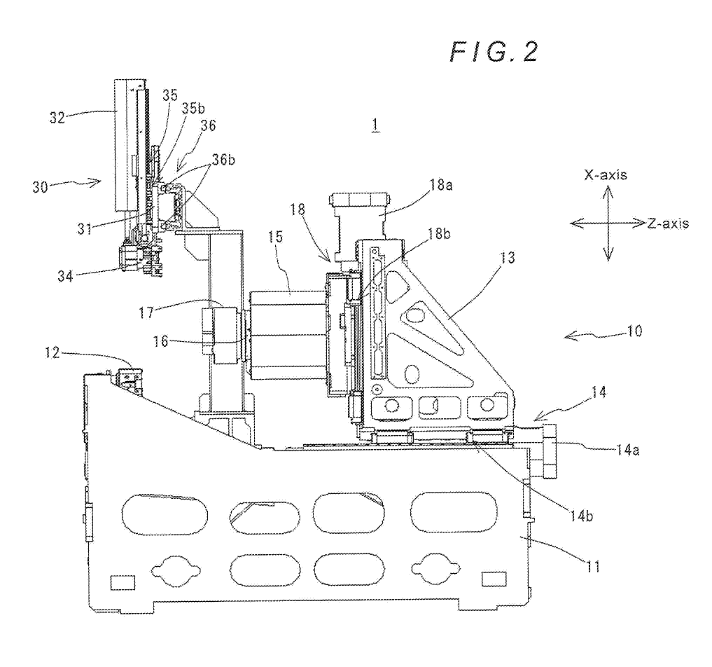

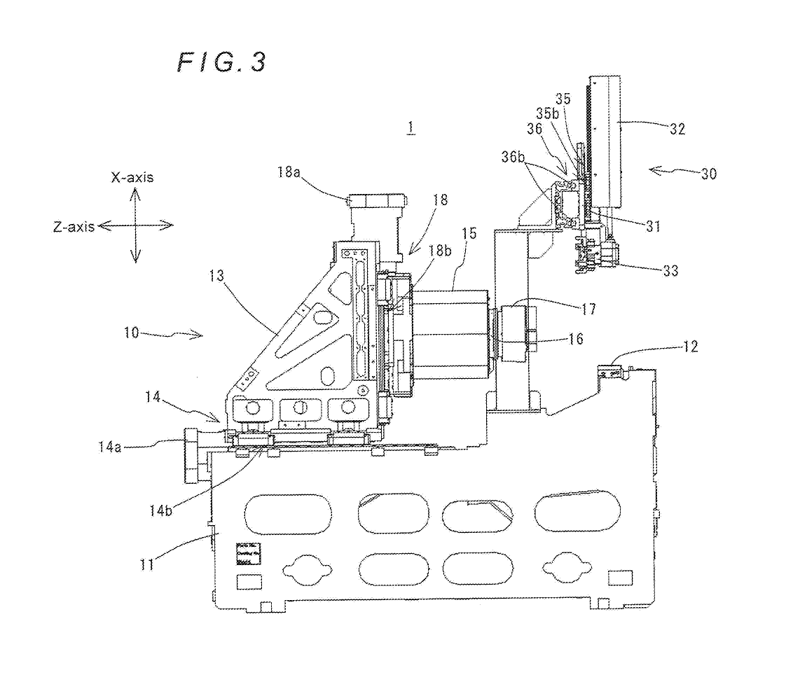

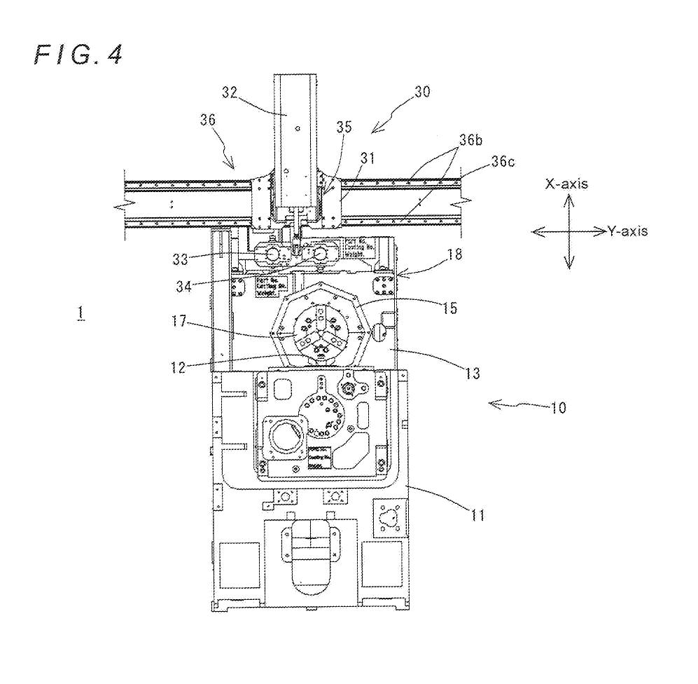

First of all, a configuration of a machine tool according to this embodiment is described. As shown in FIGS. 1 to 5, the machine tool 1 according to this embodiment consists of a machining mechanism part 10, a loading mechanism part 30, and a numerical controller 50. Each component is described below.

[Machining Mechanism Part]

The machining mechanism part 10 includes a bed 11, a carriage 13 disposed on the bed 11, a spindle head 15 disposed on a front surface of the carriage 13, a spindle 16 held by the spindle head 15 to be rotatable about a horizontal center axis thereof, a spindle chuck 17 attached to a front end surface of the spindle 16, and a turret 12 disposed on the bed 11 before the spindle chuck 17 to face the spindle chuck 17.

The carriage 13 is moved along a Z-axis, which is parallel to the center axis of the spindle 16, by a first-axis feed mechanism 14 arranged on the bed 11, and the spindle head 15 is moved along an X-axis, which is vertical and orthogonal to the Z-axis, by a second-axis feed mechanism 18 disposed on the front surface of the carriage 13.

Note that the first-axis feed mechanism 14 includes a ball screw (not shown) disposed along the Z-axis on the bed 11, a ball nut (not shown) screwed on the ball screw (not shown) and fixed to the carriage 13, a first-axis servo motor 14a driving the ball screw (not shown), and a first-axis guide unit 14b disposed on the bed 11 for guiding movement of the carriage 13 along the Z-axis. Rotating the ball screw (not shown) with the first-axis servo motor 14a causes the carriage 13 to move along the Z-axis.

Similarly, the second-axis feed mechanism 18 includes a ball screw (not shown) disposed along the X-axis on the front surface of the carriage 13, a ball nut (not shown) screwed on the ball screw (not shown) and fixed to the spindle head 15, and a second-axis servo motor 18a driving the ball screw (not shown), and a second-axis guide unit 18b disposed on the front surface of the carriage 13 for guiding movement of the spindle head 15 along the X-axis. Rotating the ball screw (not shown) with the second-axis servo motor 18a causes the spindle head 15 to move along the X-axis.

The spindle 16 is rotated by a spindle motor (not shown) incorporated in the spindle head 15, and the spindle chuck 17 clamps a workpiece. Furthermore, the turret 12 has appropriate tools attached thereto.

[Loading Mechanism Part]

The loading mechanism part 30 includes a first holding chuck 33 and a second holding chuck 34 which are arranged in parallel with a predetermined space between them along a direction of a Y-axis, which is orthogonal to both the X-axis and the Z-axis, a support rest 32 supporting the first holding chuck 33 and the second holding chuck 34, a movable rest 31 supporting the support rest 32, a third-axis feed mechanism 35 arranged on a front surface of the movable rest 31 and moving the support rest 32 in a direction extending along the X-axis, and a fourth-axis feed mechanism 36 moving the movable rest 31 in a direction extending along the Y-axis.

The third-axis feed mechanism 35 includes a ball screw (not shown) disposed along the X-axis on the front surface of the movable rest 31, a ball nut (not shown) screwed on the ball screw (not shown) and fixed to the support rest 32, a third-axis servo motor 35a driving the ball screw (not shown), and a third-axis guide unit 35b disposed on the front surface of the movable rest 31 for guiding movement of the support rest 32 along the X-axis. Rotating the ball screw (not shown) with the third-axis servo motor 35a causes the support rest 32 to move along the X-axis.

Further, the fourth-axis feed mechanism 36 includes a fourth-axis guide unit 36b having a travelling rail disposed along the Y-axis and guiding movement of the movable rest 31 along the Y-axis, a rack 36c disposed along the travelling rail, a pinion gear (not shown) arranged on the movable rest 31 and meshing with the rack 36c, and a fourth-axis servo motor 36a driving the pinion gear (not shown). Driving the pinion gear (not shown) with the fourth-axis servo motor 36a causes the movable rest 31 to move in the Y-axis direction.

[Numerical Controller]

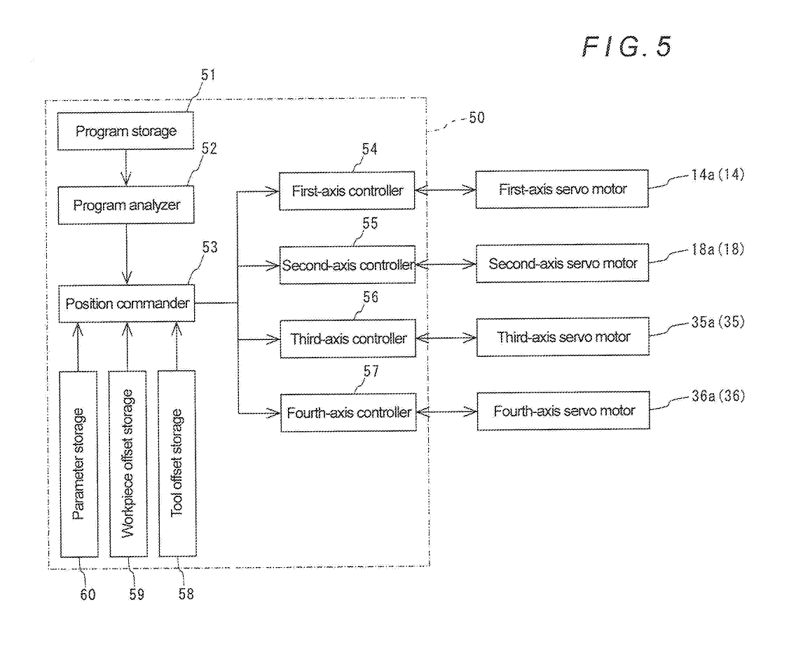

The numerical controller 50 is composed of a single CPU and hardware, such as an ROM, an RAM, and a hard disk. The hardware forms functional units as shown in FIG. 5: a program storage 51, a program analyzer 52, a position commander 53, a first-axis controller 54, a second-axis controller 55, a third-axis controller 56, a fourth-axis controller 57, a tool offset storage 58, a workpiece offset storage 59, and a parameter storage 60.

The program storage 51 is a functional unit that stores therein machining programs for executing machining in the machining mechanism part 10 and a workpiece transfer operation program for executing a workpiece transfer operation between the loading mechanism part 30 and the spindle chuck 17.

Note that the machining programs contain a position command with respect to a workpiece coordinate system that has its origin at a workpiece zero point, whereas the workpiece transfer operation program contains a position command with respect to a machine coordinate system that has its origin at a machine zero point. Further, the workpiece transfer operation program functions as a subprogram (subroutine) of the machining programs; therefore, for example, the machining programs contain, in their respective pre-machining blocks, a code for starting the workpiece transfer operation program.

The tool offset storage 58 is a functional unit that stores therein an offset amount for each of the tools attached to the turret 12, the offset amount being determined based on the tool length of the tool.

The workpiece offset storage 59 is a functional unit that stores therein a workpiece offset amount. Note that the workpiece offset amount compensates for a difference between the workpiece zero point and the machine zero point when a program containing a position command with respect to the workpiece coordinate system having its origin at the workpiece zero point is executed and thereby a certain driving unit is numerically controlled with respect to the machine coordinate system having its origin at the machine zero point.

The parameter storage 60 is a functional unit that stores therein various parameters. In this embodiment, especially, whether to perform control taking workpiece offset into account is stored as a parameter. The use of workpiece offset is set at ON for execution of the machining programs, whereas the use of workpiece offset is set at OFF for execution of the workpiece transfer operation program. That is, the parameter setting is such that workpiece offset is used when the machining programs are executed, and workpiece offset is not used when the workpiece transfer operation program is executed.

The program analyzer 52 is a functional unit that reads out a machining program stored in the program storage 51 and executes the machining program. The program analyzer 52 recognizes operation commands contained in the machining program and transmits the recognized operation commands to the position commander 53. The operation commands in the machining program include at least a moving position and a feed speed for the first-axis feed mechanism 14 and a moving position and a feed speed for the second-axis feed mechanism 18.

Further, as described above, the machining program contains a code for starting the workpiece transfer operation program as a subprogram; upon recognizing this code, the program analyzer 52 reads out and executes the workpiece transfer operation program stored in the program storage 51, recognizes operation commands contained in the workpiece transfer operation program, and transmits the recognized operation commands to the position commander 53. The operation commands in the workpiece transfer operation program include at least a moving position and a feed speed for the first-axis feed mechanism 14, a moving position and a feed speed for the third-axis feed mechanism 35, and a moving position and a feed speed for the fourth-axis feed mechanism 36.

Based on the operation commands for the first-axis feed mechanism 14, second-axis feed mechanism 18, third-axis feed mechanism 35, and fourth-axis feed mechanism 36 received from the program analyzer 52, the position commander 53 generates position commands for them, and transmits the position command for the first-axis feed mechanism 14 to the first-axis controller 54, the position command for the second-axis feed mechanism 18 to the second-axis controller 55, the position command for the third-axis feed mechanism 35 to the third-axis controller 56, and the position command for the fourth-axis feed mechanism 36 to the fourth-axis controller 57.

Further, when the position commander 53 generates position commands, in the case where the program being analyzed by the program analyzer 52 is a machining program, the position commander 53 recognizes, based on the parameter setting stored in the parameter storage 60, that workpiece offset is used for control, and generates, based on the workpiece offset amount stored in the workpiece offset storage 59 and the tool offset amount for a currently used tool of the tool offset amounts stored in the tool offset storage 58, position commands taking into account the workpiece offset amount and the tool offset amount.

In contrast, in the case where the program being analyzed by the program analyzer 52 is the workpiece transfer operation program, the position commander 53 recognizes, based on the parameter setting stored in the parameter storage 60, that workpiece offset is not used for control, and generates position commands not taking into account workpiece offset.

Further, the first-axis controller 54 feedback-controls the first-axis servo motor 14a of the first-axis feed mechanism 14 in accordance with the position command received from the position commander 53. Similarly, the second-axis controller 55 feedback-controls the second-axis servo motor 18a of the second-axis feed mechanism 18 in accordance with the position command received from the position commander 53, the third-axis controller 56 feedback-controls the third-axis servo motor 35a of the third-axis feed mechanism 35 in accordance with the position command received from the position commander 53, and the fourth-axis controller 57 feedback-controls the fourth-axis servo motor 36a of the fourth-axis feed mechanism 36 in accordance with the position command received from the position commander 53.

2. Operation of Machine Tool

Next, an operation of the machine tool 1 having the above-described configuration is described.

In this embodiment, once a machining program stored in the program storage 51 is executed by the numerical controller 50, first, the workpiece transfer operation program is executed before machining is started by the machining mechanism part 10, whereby the workpiece transfer operation is executed between the loading mechanism part 30 and the spindle chuck 17.

Note that the first holding chuck 33 of the loading mechanism part 30 is in an opened state, the second holding chuck 34 clamps an unmachined workpiece, and, in the Y-axis direction, the loading mechanism part 30 is positioned at a position (loader standby position) at which downward movement in the X-axis direction allows the first holding chuck 33 to face the spindle chuck 17. Further, the spindle chuck 17 clamps a machined workpiece and the carriage 13 has been retreated to a rear position (spindle retreated position) along the Z-axis so that the machined workpiece clamped by the spindle chuck 17 does not interfere with the first holding chuck 33 and the second holding chuck 34 when they are moved downward in the X-axis direction.

First, in accordance with the workpiece transfer operation program, the first-axis servo motor 14a and the third-axis servo motor 35a are simultaneously driven in rapid traverse (at high speed) by the numerical controller 50, whereby the support rest 32 of the loading mechanism part 30 is moved downward at high speed along the X-axis to a position (loader-side transfer position) at which the first holding chuck 33 faces the spindle chuck 17, and the carriage 13 is moved forward at high speed along the Z-axis to a position (spindle standby position) at which the machined workpiece clamped by the spindle chuck 17 is positioned in front of the first holding chuck 33.

Subsequently, the first-axis servo motor 14a is driven at low speed, whereby the carriage 13 is moved forward at low speed along the Z-axis to a position (spindle-side transfer position) for causing the machined workpiece clamped by the spindle chuck 17 to be clamped by the first holding chuck 33.

Thereafter, the machined workpiece is clamped by the first holding chuck 33 and simultaneously the spindle chuck 17 unclamps the machined workpiece. Subsequently, the first-axis servo motor 14a is driven at high speed, whereby the carriage 13 is moved backward at high speed along the Z-axis to the spindle standby position.

Subsequently, the fourth-axis servo motor 36a is driven at high speed, whereby the movable rest 31 of the loading mechanism part 30 is moved leftward at high speed along the Y-axis to a position at which the second holding chuck 34 faces the spindle chuck 17. Thereafter, the first-axis servo motor 14a is driven at low speed again, whereby the carriage 13 is moved forward at low speed along the Z-axis to the spindle-side transfer position.

Subsequently, the unmachined workpiece is clamped by the spindle chuck 17 and simultaneously the second holding chuck 34 unclamps the unmachined workpiece. Subsequently, the first-axis servo motor 14a is driven at high speed, whereby the carriage 13 is moved backward at high speed along the Z-axis to the spindle standby position.

Subsequently, the first-axis servo motor 14a and the third-axis servo motor 35a are simultaneously driven at high speed, whereby the support rest 32 of the loading mechanism part 30 is moved upward at high speed along the X-axis to the initial height position and the carriage 13 is moved backward along the Z-axis to the spindle retreated position at which the carriage 13 was initially positioned.

After the above-described operations, the workpiece transfer operation between the loading mechanism part 30 and the spindle chuck 17 finishes. Once the workpiece transfer operation finishes after the above-described operations, the subsequent machining program is executed in the numerical controller 50, whereby the unmachined workpiece clamped by the spindle chuck 17 is machined by operation of the machining mechanism part 10. At the same time, the workpiece transfer operation program is executed in parallel with the machining program to carry out a preparation operation of, after moving the movable rest 31 of the loading mechanism part 30 along the Y-axis to an appropriate position, discharging the machined workpiece clamped by the first holding chuck 33 and clamping an unmachined workpiece with the second holding chuck 34, and then moving the loading mechanism part 30 to the loader standby position. After this preparation operation finishes, the loading mechanism part 30 is in a standby state until the machining in the machining mechanism part 10 finishes.

Once the machining in the machining mechanism part 10 finishes, the above-described operations are performed repeatedly.

As described in detail above, in the machine tool 1 according to this embodiment, in the operations for transferring workpieces between the loading mechanism part 30 and the spindle chuck 17, the operation of driving the first-axis servo motor 14a to move the spindle chuck 17 to the spindle standby position and the operation of driving the third-axis servo motor 35a to move the first holding chuck 33 of the loading mechanism part 30 to the loader-side transfer position are performed simultaneously, and the operation of driving the first-axis servo motor 14a to move the spindle chuck 17 to the spindle retracted position and the operation of driving the third-axis servo motor 35a to move the support rest 32 of the loading mechanism part 30 to the same height position as the loader standby position are performed simultaneously. Therefore, as compared with the conventional machine tool performing these operations separately and independently, it is possible to shorten the operation time for these operations, and therefore it is possible to reduce costs for production using the machine tool 1.

Further, because the first holding chuck 33 and the second holding chuck 34 are used to transfer a machined workpiece from the spindle chuck 17 to the first holding chuck 33 and attach an unmachined workpiece from the second holding chuck 34 to the spindle chuck 17, it is possible to execute detachment of a machined workpiece held by the spindle chuck 17 and attachment of an unmachined workpiece to the spindle chuck 17 in fewer operations. Therefore, it is possible to further shorten the operation time for the detachment and attachment of workpieces from and to the spindle chuck 17, and therefore it is possible to further reduce the costs for production using the machine tool 1.

Further, in this embodiment, the numerical controller 50 is configured to include a single CPU and configured to, when executing the workpiece transfer operation program, process the workpiece transfer operation program with the single CPU to numerically control the first-axis servo motor 14a of the machining mechanism part 10 and the third-axis servo motor 35a and fourth-axis servo motor 36a of the loading mechanism part 30. Therefore, it is possible to, when the first-axis servo motor 14a and the third-axis servo motor 35a are simultaneously numerically controlled, execute processings, such as causing their operation timings to coincide with each other, quickly with wasted time eliminated as much as possible.

Further, when controlling the first-axis feed mechanism 14 (first-axis servo motor 14a), the second-axis feed mechanism 18 (second-axis servo motor 18a), the third-axis feed mechanism 35 (third-axis servo motor 35a), and the fourth-axis feed mechanism 36 (fourth-axis servo motor 36a), which are to be numerically controlled, the numerical controller 50 usually numerically controls them with respect to the machine coordinate system having its origin at the machine zero point. On the other hand, machining in the machining mechanism part is carried out using a machining program that contains a position command for the workpiece coordinate system having its origin at the workpiece zero point.

Therefore, also in this embodiment, when numerically controlling the first-axis feed mechanism 14 (first-axis servo motor 14a) and the second-axis feed mechanism 18 (second-axis servo motor 18a) in accordance with a machining program, the numerical controller 50 numerically controls the first-axis feed mechanism 14 (first-axis servo motor 14a) and the second-axis feed mechanism 18 (second-axis servo motor 18a) using the workpiece offset amount for compensating for a difference between the workpiece zero point and the machine zero point.

In contrast, the workpiece transfer operation between the first holding chuck 33 and second holding chuck 34 of the loading mechanism part 30 and the spindle chuck 17, which is carried out by operations of the machining mechanism part 10, first-axis feed mechanism 14, and third-axis feed mechanism 35 of the loading mechanism part 30, is executed in accordance with the workpiece transfer operation program that contains a position command for the machine coordinate system. Therefore, when the workpiece transfer operation program is executed and thereby the first-axis feed mechanism 14 (first-axis servo motor 14a) and the third-axis feed mechanism 35 (third-axis servo motor 35a) are numerically controlled, if control using the workpiece offset amount is maintained, it is not possible to accurately control the positional relationship between the spindle chuck 17 and the first holding chuck 33 and second holding chuck 34.

Accordingly, in this embodiment, when the workpiece transfer operation program that contains a position command for the machine coordinate system is executed and thereby the first-axis feed mechanism 14 (first-axis servo motor 14a) and the third-axis feed mechanism 35 (third-axis servo motor 35a) are numerically controlled in the machine coordinate system, the first-axis feed mechanism 14 (first-axis servo motor 14a) and the third-axis feed mechanism 35 (third-axis servo motor 35a) are numerically controlled without using the workpiece offset amount.

Further, in this embodiment, because workpieces are transferred between the first holding chuck 33 and second holding chuck 34 arranged in parallel along the Y-axis direction and the spindle chuck 17, it is possible to execute detachment of a machined workpiece held by the spindle chuck 17 and attachment of a new workpiece to the spindle chuck in fewer operations. Therefore, it is possible to further shorten the operation time for the detachment and attachment of workpieces from and to the spindle chuck 17, and therefore it is possible to further reduce the costs for production using the machine tool 1.

Hereinbefore, one specific embodiment of the present invention has been described. However, the present invention is not limited thereto and can be implemented in other modes.

For example, although the above embodiment is configured such that the first holding chuck 33 and the second holding chuck 34 are arranged in parallel horizontally along the Y-axis, a configuration is possible in which they are arranged in parallel vertically along the X-axis.

Further, although the above embodiment is configured such that the use of workpiece offset in the machining programs and the non-use of workpiece offset in the workpiece transfer operation program are determined by a parameter, the present invention is not limited thereto and a configuration is possible in which commands (codes) for defining the use and non-use of workpiece offset are set, the command for the use of workpiece offset is contained in the machining programs, and the command for the non-use of workpiece offset is contained in the workpiece transfer operation program.

Furthermore, although the above embodiment shows, as an example, the machining mechanism part 10 including a single spindle head 15, the present invention is not limited thereto and, as a matter of course, the machining mechanism part 10 may include a plurality of spindle heads 15.

### REFERENCE SIGNS LIST

1 Machine tool
10 Machining mechanism part
11 Bed
12 Turret
13 Carriage
14 First-axis feed mechanism
14a First-axis servo motor
14b First-axis guide unit
15 Spindle head
16 Spindle
17 Spindle chuck
18 Second-axis feed mechanism 18
18a Second-axis servo motor
18b Second-axis guide unit
30 Loading mechanism part
31 Movable rest
32 Support rest
33 First holding chuck
34 Second holding chuck
35 Third-axis feed mechanism
35a Third-axis servo motor
35b Third-axis guide unit
36 Fourth-axis feed mechanism
36a Fourth-axis servo motor
36b Fourth-axis guide unit
50 Numerical controller
51 Program storage
52 Program analyzer
53 Position commander
54 First-axis controller
55 Second-axis controller
56 Third-axis controller
57 Fourth-axis controller
58 Tool offset storage
59 Workpiece offset storage
60 Parameter storage

1. A machine tool, comprising:
a machining mechanism part including a spindle holding a workpiece and rotating the workpiece about a center axis of the spindle, a tool rest holding a tool, a first-axis feed mechanism moving the spindle forward and backward along a first axis extending along the center axis of the spindle, and a second-axis feed mechanism relatively moving the spindle and the tool rest along a second axis orthogonal to the first axis;
a loading mechanism part transferring and receiving the workpiece to and from the spindle at a transfer position to which the spindle is moved forward along the first axis, the loading mechanism part including a holding part holding the workpiece, and a third-axis feed mechanism moving the holding part in a direction of a third axis orthogonal to the first axis to position the holding part at the transfer position; and
a numerical controller numerically controlling at least the first-axis feed mechanism, the second-axis feed mechanism, and the third-axis feed mechanism,
the numerical controller being configured to, for transferring the workpiece between the spindle and the loading mechanism part, execute an operation of moving the spindle toward the transfer position with the first-axis feed mechanism and an operation of positioning the holding part at the transfer position with the third-axis feed mechanism in a manner such that the operations at least partially overlap.

2. The machine tool according to claim 1, wherein:
the first axis is horizontally arranged and the third axis is vertically arranged;
the loading mechanism part includes two said holding parts arranged in parallel along the third axis; and
the numerical controller is configured to control an operation of the third-axis feed mechanism so as to selectively position one of the holding parts at the transfer position.

3. The machine tool according to claim 1, wherein:
the first axis is horizontally arranged and the third axis is vertically arranged;
the loading mechanism part includes two said holding parts arranged in parallel along a horizontal fourth axis orthogonal to the first axis, and a fourth-axis feed mechanism moving the holding parts along the fourth axis; and
the numerical controller is configured to control operations of the third-axis feed mechanism and fourth-axis feed mechanism so as to selectively position one of the holding parts at the transfer position.

4. The machine tool according to claim 1, wherein the numerical controller includes a single CPU and is configured to process a workpiece transfer operation program with the CPU to simultaneously numerically control the first-axis feed mechanism of the machining mechanism part and the third-axis feed mechanism of the loading mechanism part.

5. The machine tool according to claim 2, wherein the numerical controller includes a single CPU and is configured to process a workpiece transfer operation program with the CPU to simultaneously numerically control the first-axis feed mechanism of the machining mechanism part and the third-axis feed mechanism of the loading mechanism part.

6. The machine tool according to claim 3, wherein the numerical controller includes a single CPU and is configured to process a workpiece transfer operation program with the CPU to simultaneously numerically control the first-axis feed mechanism of the machining mechanism part and the third-axis feed mechanism of the loading mechanism part.

7. The machine tool according to claim 4, wherein the numerical controller is configured to,
when executing a machining program containing a position command for a workpiece coordinate system having its origin at a workpiece zero point, and numerically controlling the first-axis feed mechanism and the second-axis feed mechanism with respect to a machine coordinate system having its origin at a machine zero point, numerically control the first-axis feed mechanism and the second-axis feed mechanism using a workpiece offset amount for compensating for a difference between the workpiece zero point and the machine zero point, and
when executing the workpiece transfer operation program containing a position command for the machine coordinate system, and numerically controlling the first-axis feed mechanism and the third-axis feed mechanism with respect to the machine coordinate system, numerically control the first-axis feed mechanism and the third-axis feed mechanism without using the workpiece offset amount.

8. The machine tool according to claim 5, wherein the numerical controller is configured to,
when executing a machining program containing a position command for a workpiece coordinate system having its origin at a workpiece zero point, and numerically controlling the first-axis feed mechanism and the second-axis feed mechanism with respect to a machine coordinate system having its origin at a machine zero point, numerically control the first-axis feed mechanism and the second-axis feed mechanism using a workpiece offset amount for compensating for a difference between the workpiece zero point and the machine zero point, and
when executing the workpiece transfer operation program containing a position command for the machine coordinate system, and numerically controlling the first-axis feed mechanism and the third-axis feed mechanism with respect to the machine coordinate system, numerically control the first-axis feed mechanism and the third-axis feed mechanism without using the workpiece offset amount.

9. The machine tool according to claim 6, wherein the numerical controller is configured to,
when executing a machining program containing a position command for a workpiece coordinate system having its origin at a workpiece zero point, and numerically controlling the first-axis feed mechanism and the second-axis feed mechanism with respect to a machine coordinate system having its origin at a machine zero point, numerically control the first-axis feed mechanism and the second-axis feed mechanism using a workpiece offset amount for compensating for a difference between the workpiece zero point and the machine zero point, and
when executing the workpiece transfer operation program containing a position command for the machine coordinate system, and numerically controlling the first-axis feed mechanism and the third-axis feed mechanism with respect to the machine coordinate system, numerically control the first-axis feed mechanism and the third-axis feed mechanism without using the workpiece offset amount.

10. The machine tool according to claim 7, wherein the numerical controller is configured to determine whether to apply the workpiece offset amount based on a preset parameter and configured, in accordance with setting of the parameter, not to apply the workpiece offset amount when executing the workpiece transfer operation program.

11. The machine tool according to claim 8, wherein the numerical controller is configured to determine whether to apply the workpiece offset amount based on a preset parameter and configured, in accordance with setting of the parameter, not to apply the workpiece offset amount when executing the workpiece transfer operation program.

12. The machine tool according to claim 9, wherein the numerical controller is configured to determine whether to apply the workpiece offset amount based on a preset parameter and configured, in accordance with setting of the parameter, not to apply the workpiece offset amount when executing the workpiece transfer operation program.

13. The machine tool according to claim 7, wherein the numerical controller is configured to determine whether to apply the workpiece offset amount in accordance with a command for defining whether to apply the workpiece offset amount, the command being contained in the programs.

14. The machine tool according to claim 8, wherein the numerical controller is configured to determine whether to apply the workpiece offset amount in accordance with a command for defining whether to apply the workpiece offset amount, the command being contained in the programs.

15. The machine tool according to claim 9, wherein the numerical controller is configured to determine whether to apply the workpiece offset amount in accordance with a command for defining whether to apply the workpiece offset amount, the command being contained in the programs.
